(19) United States
(12) Patent Application Publication
(10) Pub. No.: US 2005/0189858 A1
(43) Pub. Date: Sep. 1, 2005

(54) Spark plug

(76) Inventors: Chin-Fa Chang, Hsintien City (TW); Jun-Wei Pan, Milwaukee, WI (US)

Correspondence Address: CHIN-FA CHANG, 4F. NO. 19, CHANG HSING RD., HSINTIEN CITY, TAIPEI HSIEN, 231, TW

(21) Appl. No.: 10/788,344

(22) Filed: Mar. 1, 2004

(51) Int. Cl. H01T 13/20

(52) U.S. Cl. 313/141

(57) ABSTRACT

A spark plug comprises a center electrode, an electric bar in the center electrode, the electric bar being composed of about 50 wt % to about 75 wt % of binder, about 25 wt % to about 24 wt % of carbon powder, and about 25 wt % to about 1 wt % of magnesium oxide, and including a resistor, a ceramic insulation shell sleeved on the center electrode and including a ceramic cylindrical member at an open end spaced apart from the center electrode by a gap, and a metal shell sleeved on the insulation shell. The center electrode comprises a flat enlarged end for partially covering and supporting the ceramic cylindrical member. The spark plug has the advantages of increased efficiency, increased output torque by increasing electric potential by the electric bar, and decreased pollutant contained in exhaust gas. Also, the cylinder is prevented from being damaged by the broken ceramic cylindrical member.

### BACKGROUND OF THE INVENTION

1. Field of the Invention

The present invention relates to spark plugs of internal-combustion engine and more particularly to such a spark plug with improved characteristics.

2. Description of Related Art

Spark plug is an important component of an internal-combustion engine. It is fitted into the cylinder to ignite the air/fuel mixture therewithin. A conventional spark plug 90 is shown in FIG. 7 and comprises a center electrode 91 having the other end electrically coupled to a high voltage source, and a bent ground electrode 92 having an open end proximate one end of the center electrode 91 so as to form a gap therebetween. In operation, an electric current supplied from the high voltage source is carried into the cylinder for sparking between the center electrode 91 and the ground electrode 92 (i.e., at the gap) in the presence of the air/fuel mixture. However, the prior art suffered from two disadvantages. For example, the protruding ground electrode 92 may hinder the sparking operation. Further, a lot of carbon may accumulate on the ground electrode 92 after a short period time of operation, resulting in a low efficiency and even malfunction.

Another conventional spark plug 90 without the provision of ground electrode as an improvement of the above is disclosed in Taiwanese Patent Published No. 299,924 and U.S. Pat. No. 5,718,843 as shown in FIGS. 8 and 9. The patent disclosed a center electrode 93, an insulator shell 94 sleeved on the center electrode 93, and a plurality of ring-shaped electrodes 95 formed around an open end of the insulator shell 94 as a replacement of the prior ground electrode. The patent has a higher sparking efficiency by eliminating the drawback of ground electrode. However, there is no improvement on the center electrode 93. Thus, the total performance is still low. Another drawback of the patent is that excessive heat may be generated between the center electrode 93 and the electrodes 95 when sparking frequency of the spark plug increases from 5,000 RPM (revolutions per minute) to the range of 10,000 RPM to 12,000 RPM for increasing output torque of the engine. This may cause the end of the insulator shell 94 (i.e., ceramic cylindrical member) to break after a short period of time of operation due to poor heat dissipation. The broken ceramic cylindrical member may undesirably scrape the inner wall of the cylinder.

Still another conventional spark plug 90 for an internal-combustion engine of high output torque is shown in FIGS. 10 and 11. An insulation shell 98 is sleeved on a center electrode 93. A metal shell 97 has an inwardly bent end to partially cover and support the insulation shell 98 and forms a gap 99 between itself and the center electrode 93. In operation, an electric current supplied from a high voltage source is carried into the cylinder for sparking at the gap 99 in the presence of the air/fuel mixture. It is known that cooling water is circulated in the wall of the hollow cylinder during operation. The metal shell 97 is also sleeved on the insulation shell 98. The metal shell 97 is cooled by cooling water and thus the center electrode 93 is always low in temperature. Hence, the electric current must have a very high voltage for facilitating the sparking at the gap 99 in operation. Typically, such spark plug is installed in a racing car. For other automobiles having such spark plug may not have a smooth sparking operation due to the low temperature of the center electrode 93 and the electric current only having a normal voltage. As an end, the applications of the spark plug are limited.

Referring to U.S. Pat. No. 5,718,843 again (see FIG. 9), an electric beam 96 is formed in an intermediate portion of the center electrode 93. The electric beam 96 is critical to the increase of current and voltage. However, there is no disclosure of how to improve the electric beam 96 for increasing the sparking efficiency. Thus, the need for improvement of spark plug still exists.

### SUMMARY OF THE INVENTION

It is an object of the present invention to provide a spark plug having an improved electric bar so as to increase sparking efficiency, increase output torque of the cylinder, decrease pollutant contained in exhaust gas, and increase driving safety.

It is another object of the present invention to provide a spark plug having a reduced manufacturing cost and a lower probability of malfunction.

It is still another object of the present invention to provide a spark plug in which the open end of an insulator shell (i.e., ceramic cylindrical member) does not tend to break during operation. Thus, the cylinder is prevented from being damaged by the broken ceramic cylindrical member as experienced by the prior art.

The above and other objects, features and advantages of the present invention will become apparent from the following detailed description taken with the accompanying drawings.

### BRIEF DESCRIPTION OF THE DRAWINGS

FIG. 1 is a perspective view of a first preferred embodiment of spark plug according to the invention;

FIG. 2 is a cross-sectional view of the spark plug shown in FIG. 1;

FIG. 3 is an enlarged view of a portion at the open end of the center electrode shown in FIG. 2;

FIG. 4 is a perspective view of a second preferred embodiment of spark plug according to the invention;

FIG. 5 is a plan view of the open end of the spark plug shown in FIG. 4;

FIG. 6 plots engine torque versus speed for curve A of the spark plug of the invention and curve B of the spark plug of U.S. Pat. No. 5,718,843 as comparison;

FIG. 7 is a perspective view of a conventional spark plug;

FIG. 8 is a perspective view of another conventional spark plug;

FIG. 9 is a cross-sectional view of a portion of the spark plug shown in FIG. 8;

FIG. 10 is a perspective view of still another conventional spark plug; and

FIG. 11 is a cross-sectional view of a portion of the spark plug shown in FIG. 10.

### DETAILED DESCRIPTION OF THE PREFERRED EMBODIMENTS

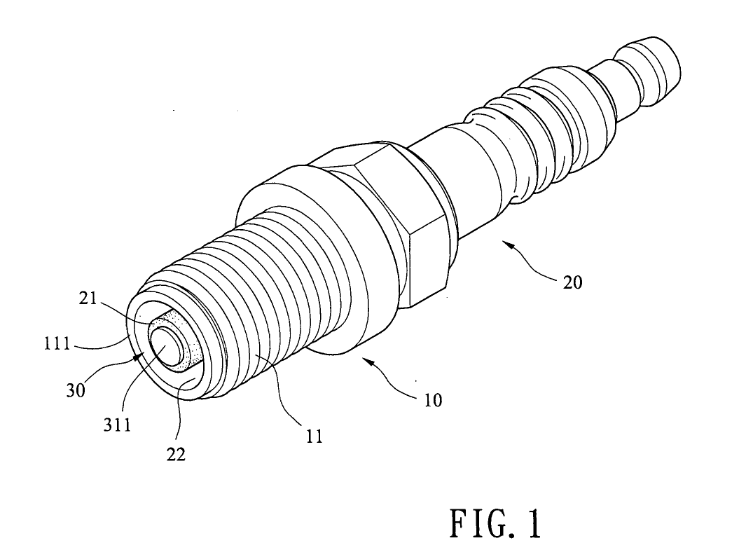

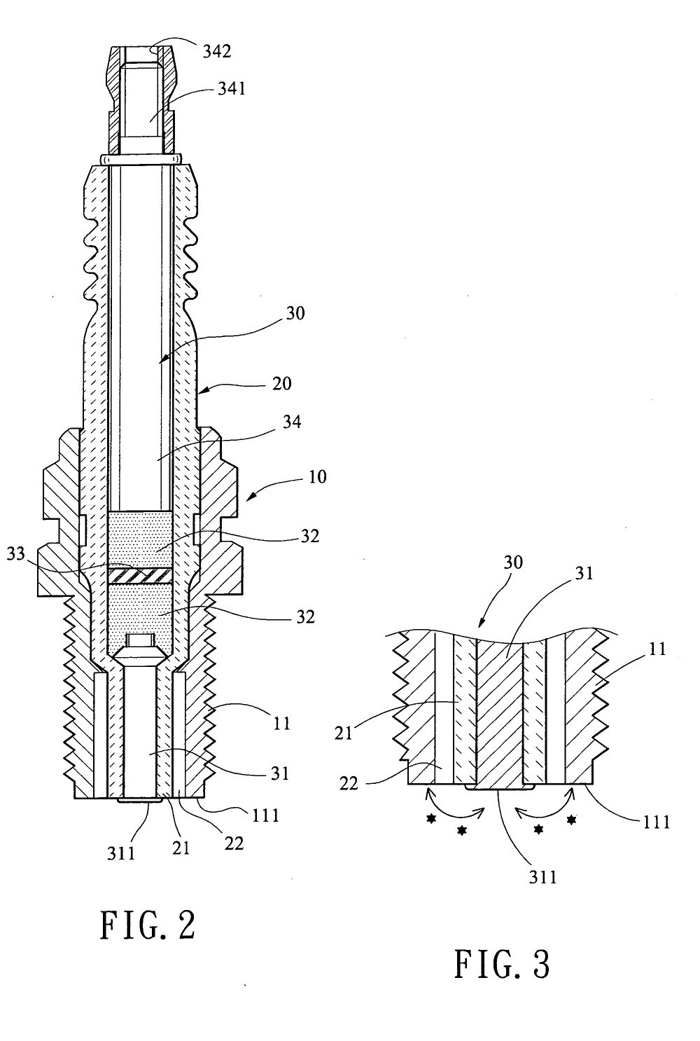

Referring to FIGS. 1 to 3, there is shown a spark plug constructed in accordance with a first preferred embodiment of the invention. The spark plug comprises a center electrode 30, an insulation shell 20 formed of ceramic material, the insulation shell 20 being sleeved on the center electrode 30, and a metal shell 10 sleeved on a portion of the insulation shell 20. The metal shell 10 comprises an externally threaded extension 11 at one end, the externally threaded extension 11 being matingly coupled to a threaded aperture (not shown) on an internal wall of the cylinder so as to mount the spark plug therein. The insulation shell 20 comprises a ceramic cylindrical member 21 at an open end thereof. A cylindrical gap 22 is formed between the ceramic cylindrical member 21 and the externally threaded extension 11. The center electrode 30 comprises a first electrode 31 at one end, a second electrode 34 at the other end, and an intermediate electric bar (i.e., potential intensifying element) 32 coupled between the electrodes 31 and 34. The first electrode 31 has a disk-shaped enlarged end 311 extended transversely to partially cover and support the front (lower) end of the ceramic cylindrical member 21. That is, a diameter of the enlarged end 311 is larger than an inner diameter of the ceramic cylindrical member 21 but smaller than an outer diameter of the ceramic cylindrical member 21. The ceramic cylindrical member 21 is thus prevented from being broken to fall into and scrape the cylinder due to high heat during operation. The electric bar 32 can increase electric current generated by a generator for increasing the sparking intensity. The composition of the electric bar 32 is about 50 weight (wt) % to about 75 wt % of binder, about 25 wt % to about 24 wt % of carbon powder, and about 25 wt % to about 1 wt % of magnesium oxide (MgO). In the preferred embodiment, the binder can be formed of glass sand, or copper powder, etc. The electric bar 32 is formed by sintering in the temperature of about 800-1000° C. The provision of the binder can increase the integrity of the electric bar 32 and intensify electric potential. A resistor 33 having an electric resistance of about 3 KΩ to about 20 KΩ is further formed on the electric bar 32. The provision of the resistor 33 can eliminate the generation of bursts and adjust the strength of electric potential. Internal threads 34 are formed at the other end of the second electrode 34. The internal threads 34 are adapted to couple to an ignition cable so as to provide an electric current of high voltage from the ignition cable to the center electrode 30.

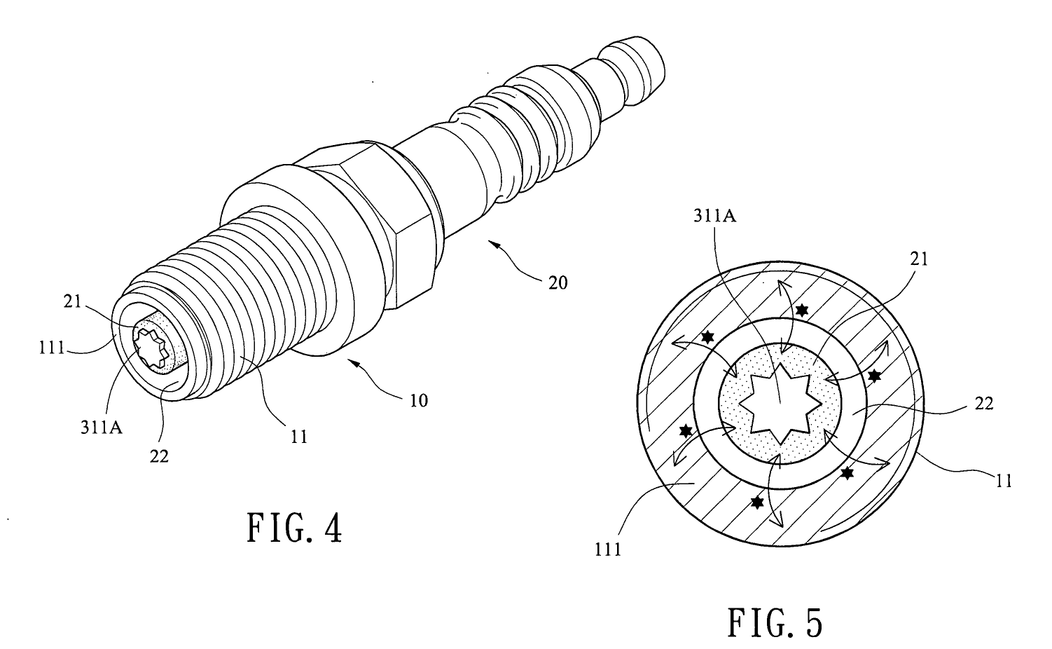

Referring to FIG. 4, there is shown a spark plug constructed in accordance with a second preferred embodiment of the invention. The difference between the first and the second preferred embodiments, i.e., the characteristic of the second preferred embodiment is detailed below. The first electrode 31 has a polygon or star-shaped enlarged end 311A or any of other shapes in other embodiments as long as the diameter of the enlarged end 311A is larger than the inner diameter of the ceramic cylindrical member 21 but smaller than the outer diameter of the ceramic cylindrical member 21.

Referring to FIG. 5 in conjunction with FIG. 3, in operation an electric current supplied from the ignition cable is carried into the cylinder via the center electrode 30 for sparking between the enlarged end 311A and an end 111 of the externally threaded extension 11 (i.e., at the gap 22) in the presence of the air/fuel mixture. The sparks are donut-shaped and are uniform. As a result, the combustion will be more complete and output torque will be more stable.

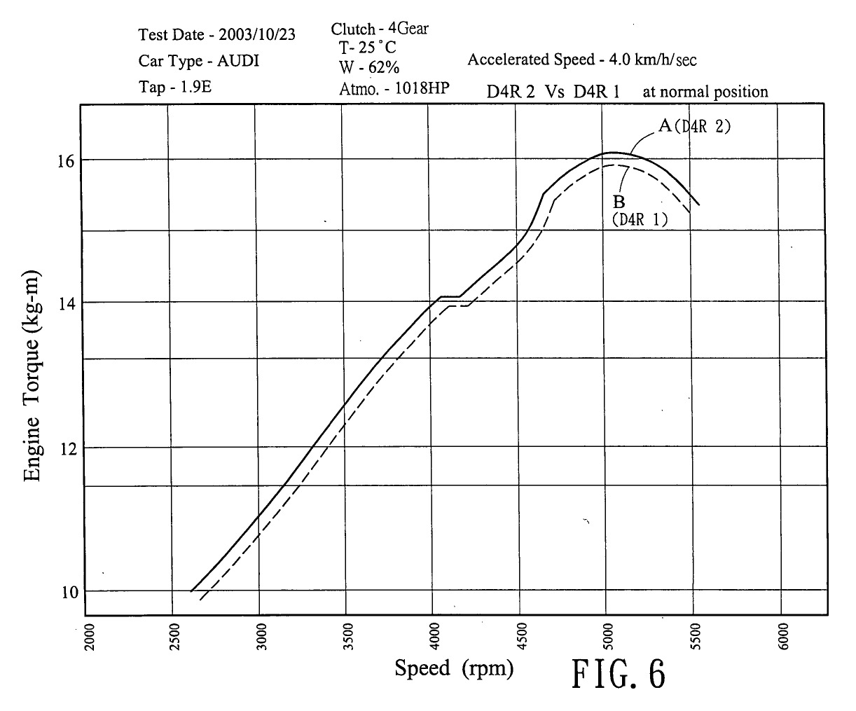

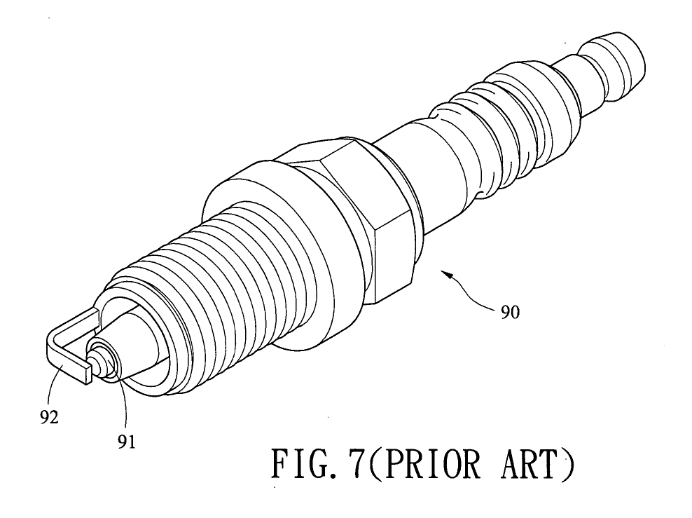

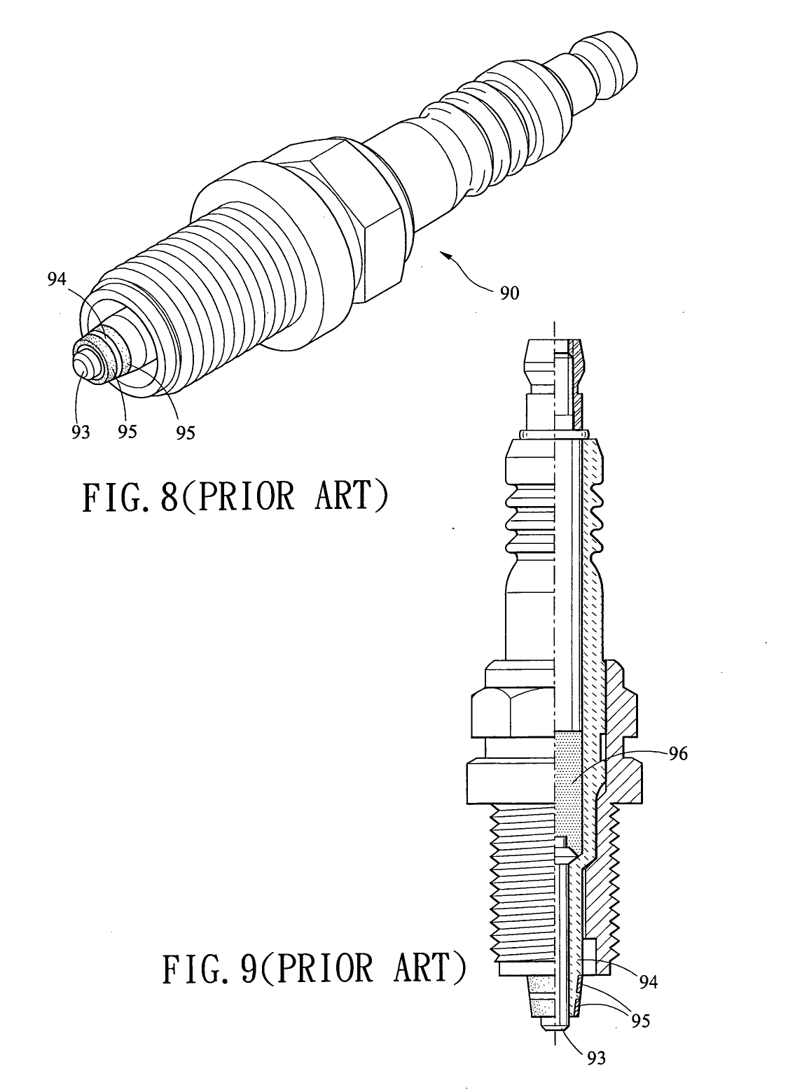

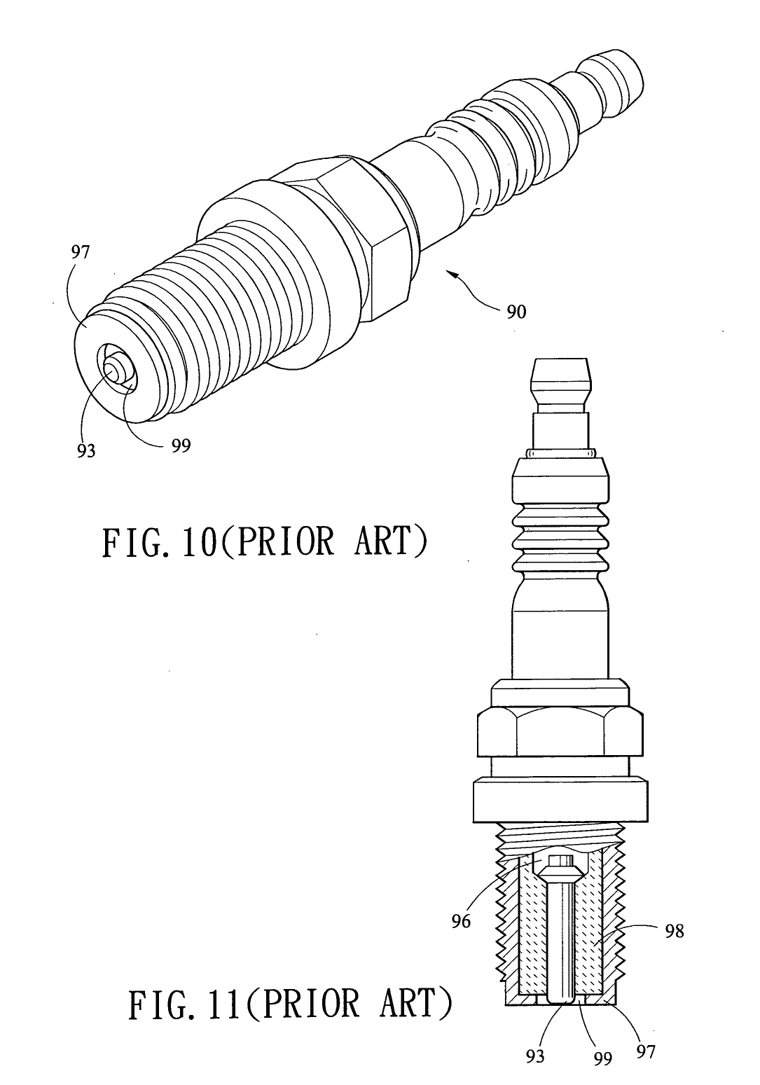

Referring to FIG. 6, it plots engine torque (in the unit of Kg-m) versus speed (in the unit of RPM) for curve “A” of the spark plug of the invention and curve “B” of the spark plug of U.S. Pat. No. 5,718,843 as comparison. It is seen that the output engine torque of the engine incorporating the spark plug of the invention is larger than that of the engine incorporating the spark plug of the prior art at a speed range of about 2,600 RPM to about 5,500 RPM.

It will be evident from the foregoing that the invention has the following advantages: Increased sparking efficiency, increased output torque of the cylinder by increasing the strength of electric potential by the electric bar, decreased pollutant contained in exhaust gas, increased driving safety, a reduced manufacturing cost, and a lower probability of malfunction. Also, the ceramic cylindrical member does not tend to break during operation. Thus, the cylinder is prevented from being damaged by the broken ceramic cylindrical member as experienced by the prior art.

While the invention herein disclosed has been described by means of specific embodiments, numerous modifications and variations could be made thereto by those skilled in the art without departing from the scope and spirit of the invention set forth in the claims.

1. A spark plug, comprising:
a center electrode;
an internal electric bar coupled to the center electrode, the internal electric bar being formed by sintering and composed of about 50 wt % to about 75 wt % of binder, about 25 wt % to about 24 wt % of carbon powder, and about 25 wt % to about 1 wt % of magnesium oxide, and further including a resistor.therein;
an insulation shell formed of ceramic material, the insulation shell being sleeved on the center electrode and including a ceramic cylindrical member at an open end spaced apart from the center electrode by a cylindrical gap; and
a metal shell sleeved on the insulation shell,
wherein the center electrode includes a flat enlarged end for partially covering and supporting the ceramic cylindrical member.

2. The spark plug of claim 1, wherein the binder is formed of glass sand.

3. The spark plug of claim 1, wherein the binder is formed of copper powder.

4. The spark plug of claim 1, wherein the enlarged end is shaped as a disk and has a diameter larger than an inner diameter of the ceramic cylindrical member.

5. The spark plug of claim 1, wherein the enlarged end is shaped as a polygon and has a diameter larger than an inner diameter of the ceramic cylindrical member.

6. The spark plug of claim 5, wherein the polygon is shaped as a star.
